(19) United States
(12) Patent Application Publication
(10) Pub. No.: US 2002/0107040 A1
(43) Pub. Date: Aug. 8, 2002

(54) Latency determination, display, characterization and equalization devices and methods

(76) Inventors: Evan Stephen Crandall, Basking Ridge, NJ (US); Glenn T. Edens, Redwood City, CA (US)

Correspondence Address: S. H. Dworetsky, AT&T Corp., P.O. Box 4110, Middletown, NJ, 07748, US

(21) Appl. No.: 09/783,263

(22) Filed: Feb. 5, 2001

(51) Int. Cl. H04B 7/00

(52) U.S. Cl. 455/517; 455/67.1; 455/502

(57) ABSTRACT

For communicating between a plurality of communication systems across a network, a communication is established between the communication systems, and an amount of latency affecting communication between the communication systems is determined. The amount of latency may be displayed to a user, compared to a required maximum amount of latency. The amount of latency may also be compensated for to avoid unequal propagation times for game signals or musical signals.

### BACKGROUND OF THE INVENTION

1. Field of Invention

This invention relates to communication systems and methods. More particularly, this invention relates to latency determination, display, characterization and equalization devices and methods for a network, such as, e.g., an Internet protocol (IP) network.

2. Description of Related Art

In the past, IP network users downloading a large quality of data through the IP network, e.g., gamers and musicians playing over an IP network, have not enjoyed the same quality of service and, in particular, the same amount of latency or propagation time across the network. Moreover, the amount of latency experienced by users may be variable. This unequal quality of service results in disturbance of the game or the music, one or more player's actions being delayed more than one or more other player's actions.

### SUMMARY OF THE INVENTION

Therefore, there is a need for determining the amount of latency between points in the network and to provide the amount of latency to a user so that the user may determine if the amount of latency is adequate for the user's use. There is also a need to characterize the amount of latency based on an application to be performed. There is a further need for providing the same amount of latency for different users involved in a relationship over the network.

In exemplary embodiments of the invention, an amount of latency affecting a user's communication signals may be determined and displayed.

In exemplary embodiments, an amount of latency affecting a user's communication signals is determined and characterized based on one or more applications to be performed.

In exemplary embodiments, an amount of latency affecting two user's communication signals is determined and an amount of latency equalization is performed.

These and other features and advantages of this invention are described in or are apparent from the following detailed description of the system and method according to exemplary embodiments of this invention.

### BRIEF DESCRIPTION OF THE DRAWINGS

The benefits of the present invention will be readily appreciated and understood from consideration of the following detailed description of the exemplary embodiments of this invention, when taken together with the accompanying drawings, in which:

FIG. 1 illustrates the effect of different latencies on different users' communication signals;

FIG. 2 illustrates a latency determination device in a communication network, in accordance with the invention;

FIG. 3 illustrates components of one exemplary embodiment of a latency amount characterization device in accordance with the invention;

FIG. 4 is a flowchart illustrating one exemplary embodiment of an amount of latency determination method in accordance with the invention;

FIG. 5 is a flowchart illustrating an exemplary embodiment of an amount of latency characterization method in accordance with the invention;

FIG. 6 illustrates components of a second exemplary embodiment of the latency amount characterization device in accordance with the invention;

FIG. 7 is a flowchart illustrating a first exemplary embodiment of an amount of latency equalization method in accordance with the invention;

FIG. 8 illustrates a second exemplary embodiment of an amount of latency determination device in a communication network, in accordance with the invention;

FIG. 9 is a flowchart illustrating a second exemplary embodiment of an amount of latency equalization method in accordance with the invention; and

FIG. 10 outlines an exemplary embodiment of a latency equalization manager.

### DETAILED DESCRIPTION OF EXEMPLARY EMBODIMENTS

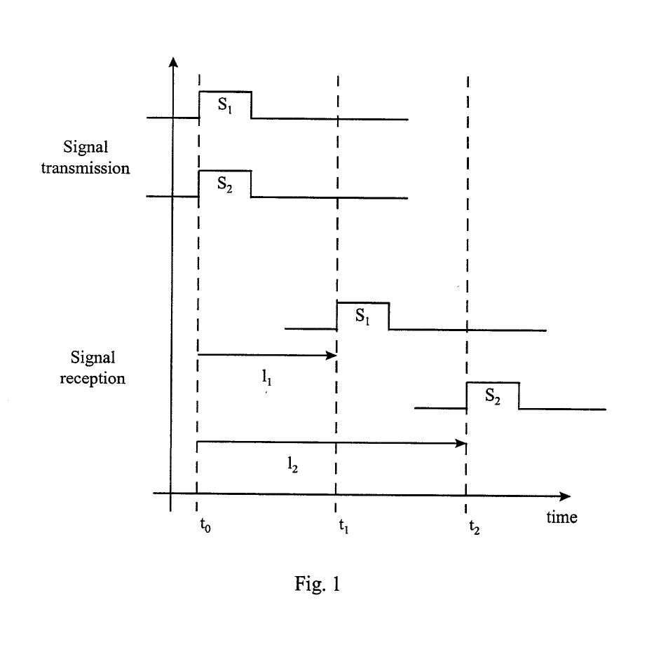

As illustrated in FIG. 1, if different latencies, or propagation time across a network, l₁ and l₂ respectively, affect signals sent simultaneously by two user communication systems at time t₀, the signals are received at different times, t₁ and t₂ respectively. This may result in unequal or asynchronous processing of the received signals.

Additionally, these different reception times may affect the quality of applications that involve the signals sent by the user communication systems. For example, if the users are playing a game that performs certain operations based on the time of reception of the signals, the difference of latencies implies an unfair competition between the players. Similarly, if the users are playing music, the difference of latencies may reduce the quality of the music resulting from the combination of signals sent by the users.

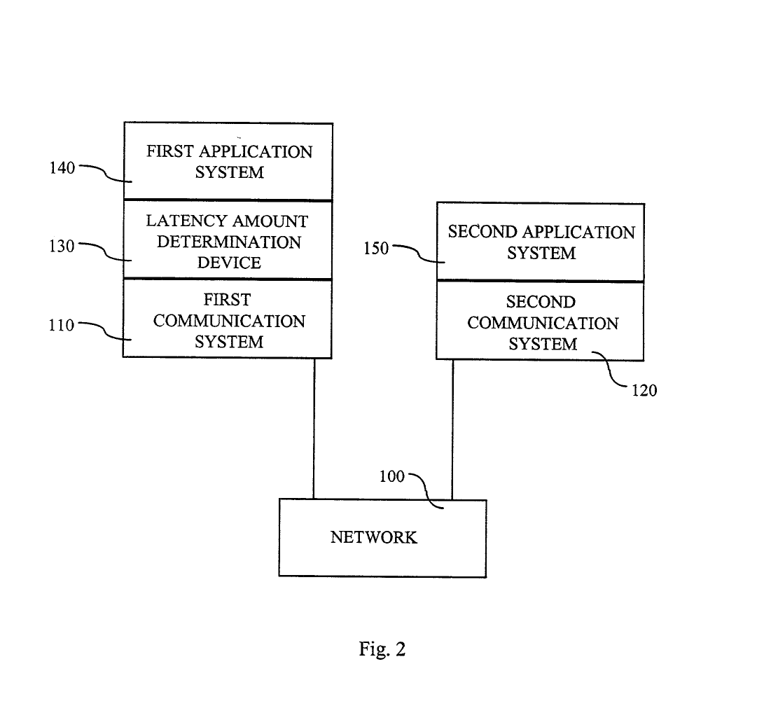

The latency amount determination device 130 shown in FIG. 2 is coupled to a first communication system 110 and to a first application system 140. The first communication system 110 is coupled to a network 100 and communicates with a second communication system 120 across the network 100. The second communication system 120 is coupled to a second application system 150.

Each communication system, 110, 120, connected to the network 100 has a unique identification which could be static or assigned when the machine connects to the network 100. The unique identification may, for example, be an IP address or a MAC address.

In the exemplary embodiment of the latency determination device according to the invention shown in FIG. 2, the first application system 140 and the second application system 150 cooperate to perform an application that requires communication across the network 100. For example, the first application system 140 may comprise the main portion of a game software and a portion of the game software that allows a first user to play with or against a second user. The second application system 150 may allow the second user to play with or against the first user across the network 100.

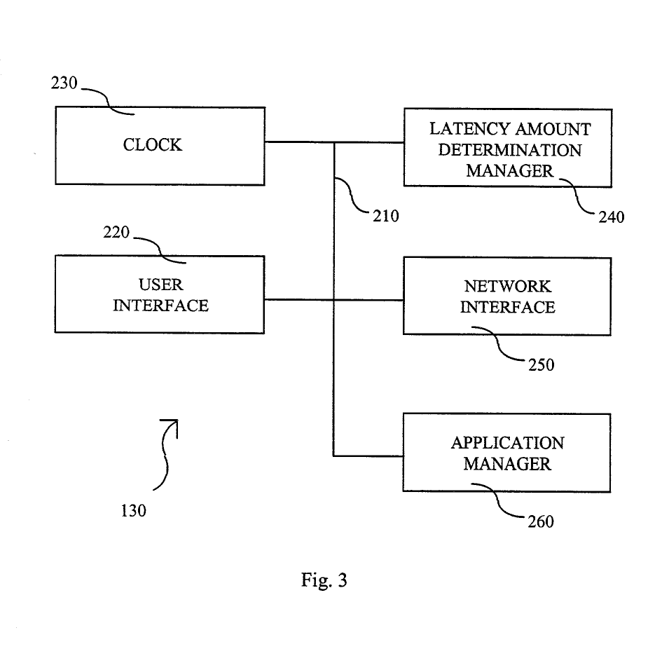

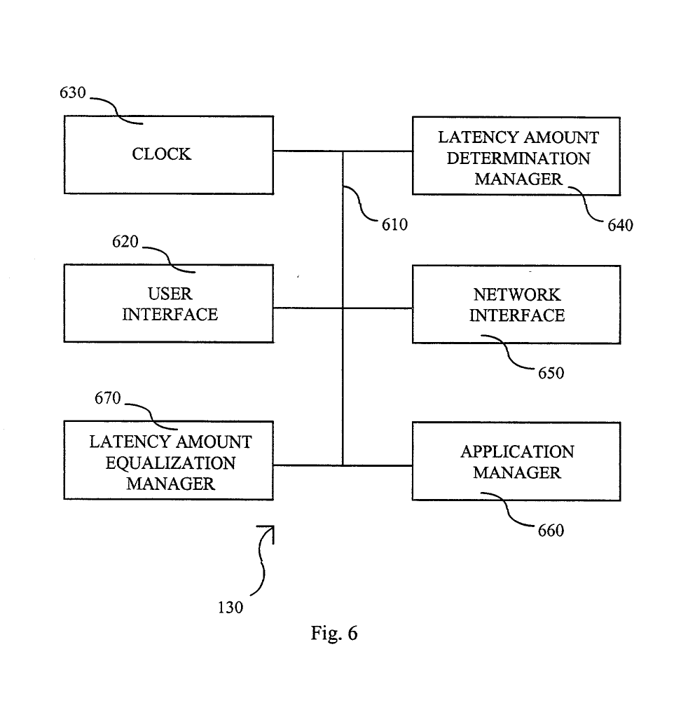

FIG. 3 illustrates a first exemplary embodiment of latency amount determination device 130. FIG. 6 illustrates a second exemplary embodiment of the latency amount determination device 130.

In the first exemplary embodiment, the latency amount determination device 130 comprises a user interface 220, a clock 230, a latency amount determination manager 240, a network interface 250 and an application manager 260 coupled together by a data and control bus 210.

The user interface 220 provides the capability for a first user to communicate with the components of the latency amount determination device 130. The user interface 220 may include one or more of a display, a sound generator, a printer, a keyboard, a mouse, a joystick, a musical instrument, a microphone, a voice recognition system, a pen, a touch screen, or any other input or output devices. The clock 230 provides information relating to time and may provide a local time, including day, hour, minute, second and thousands of second. The latency amount determination manager 240 manages the determination, display, characterization and/or equalization of a amount of latency affecting the communication across the network 100. The network interface 250 allows the amount of latency determination device to communicate with the second communication system 120 across the network 100.

The application manager 260 manages an application or applications that are used by one or more of the users.

In operation, the latency amount determination manager 240 determines the amount of latency of the communication between the first and second communication systems by establishing a communication link between the first and second communication systems and determining the duration required to convey a first signal from the first communication system 110 to the second communication system 120 across the network 100 and to convey a second signal from the second communication system 120 to the first communication system 110, across the network 100.

A first exemplary method used by the latency amount determination device 130 for determining the amount of latency involves storing a first time TI, which is the time a first signal is sent by the first communication system 110 to the second communication system 120, the first signal representing a request for an immediate response, and storing a second time T2, which is the time at which the response is received. The latency amount determination manager 240 then determines the amount of latency as being equal to the difference between the first and second stored times T1 and T2.

Amount of latency=T2−T1

This first exemplary method used by the latency amount determination device 130 for determining the amount of latency is known. For example, TCP protocol uses a technique called “ping” that consists in sending a small packet over the network and determining the travel time before the packet returns to its sender.

A second exemplary method used by the latency amount determination device 130 for determining the amount of latency involves storing a first time T′1, which is the time at which a first signal is sent from the first communication system 110 to the second communication system 120, the first signal representing a request for including, in a response, a second time T′2, which is the time at which the signal is received by the second communication system 120 and a third time T′3, which is the time at which the response is sent by the second communication system 120. The latency amount determination manager 240 then compares the first time T′1 (at which the signal is sent by the first communication system 110) and the second time T′2 (at which a second signal, which is the response is received by the first communication system 110) to determine a first difference. The latency amount determination manager 240 also compares a third time T′3 (at which the first signal is received by the second communication system 120) and a fourth time T′4 (at which a second signal, which is a response, is sent by the second communication system 120) to determine a second difference. The latency amount determination manager 240 then determines the amount of latency affecting the communication between the first communication system 110 and the second communication system 120 as equal to the difference between the first and second differences.

In other words, according to the second exemplary method, the latency amount determination manager 240 determines the amount of latency as equal to the difference between the time at which a response, the second signal, is received by the first communication system 110 , which is T′2, and the time at which the first signal is sent by the first communication system 110, which is T′1, minus the difference between the time at which the second communication system 120 received the first signal, which is T′3, and the time at which the second communication system 120 sent the response, which is T′4. This relationship is illustrated in the following formula:

Amount of latency=(T′4−T′1)−(T′3−T′2)

Optionally, in operation, the latency amount determination manager 240 drives the user interface 220 to communicate the amount of latency to the user. Also optionally, the latency amount determination manager 240 characterizes the amount of latency in view of a specific application involving communication between the first and second communication systems 110 and 120, such as a game or a musical application. This characterization may be performed by comparing the determined amount of latency with a threshold over which it is considered that the quality of service is not sufficient.

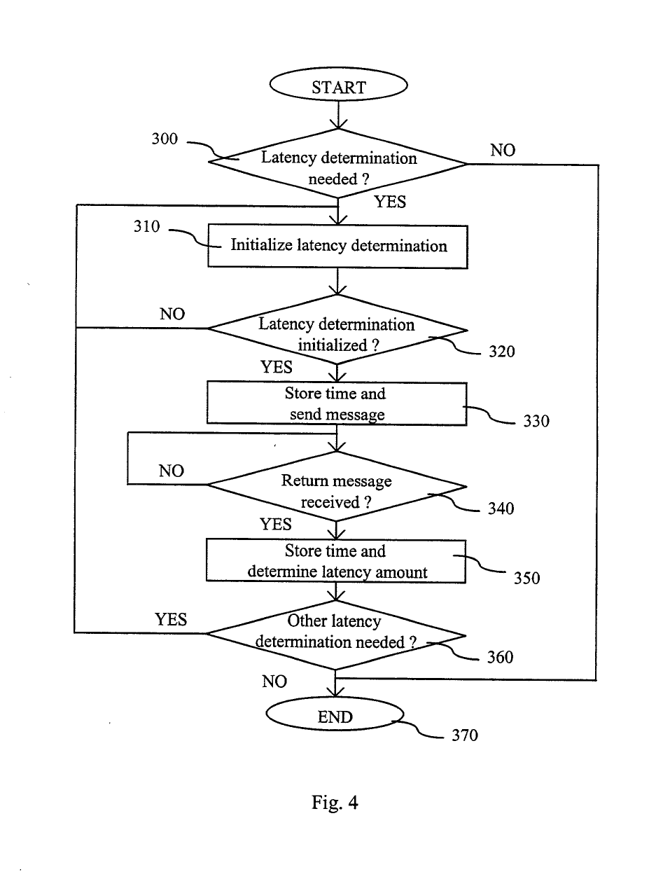

FIG. 4 is a flowchart illustrating a latency amount determination method in accordance with a second exemplary embodiment of the invention. This latency amount determination method begins in step 300, in which it is determined if a latency amount determination is needed. The step 300 may include the determination whether the application that is to be performed is a game or a musical application. If a latency amount determination is needed, control continues to step 310. Otherwise, control jumps to step 370 in which the process ends. In step 310, the latency amount determination is initialized, by, for example, establishing a communication link between each of the communication systems between which the latency amount will be determined. Control then proceeds to step 320.

In step 320, it is determined whether the necessary links have been established to initialize the latency amount determination. If so, control continues to step 330. Otherwise, control returns to step 310. In step 330, a first message is sent to the communication system relating to the latency amount to be determined and the time at which that first message was sent is stored. Control then proceeds to step 340, in which a determination is made whether a second message, being a return message, has been received from the other communication system. If so, control continues to step 350. Otherwise, control returns to step 340. At step 350, the time at which the return message is received is stored and the latency amount is determined as being equal to the difference between the time at which the second message, i.e., the return message was received, in step 340, and the time at which the first message was sent, in step 330. Control then continues to step 360.

In step 360, it is determined whether another latency amount determination is needed. This can be the case when more than one other communication system is involved in an application or when the latency amount may be variable and an average latency amount or an evolution of the amount of latency are to be determined over a period of time instead of only one latency amount. If another latency amount determination is needed, control returns to step 310. Otherwise, control continues to step 370 in which the process ends.

It should be appreciated that the latency amount determined in step 350 may be displayed to a user prior to the determination of whether an additional latency amount determination should be performed in step 360.

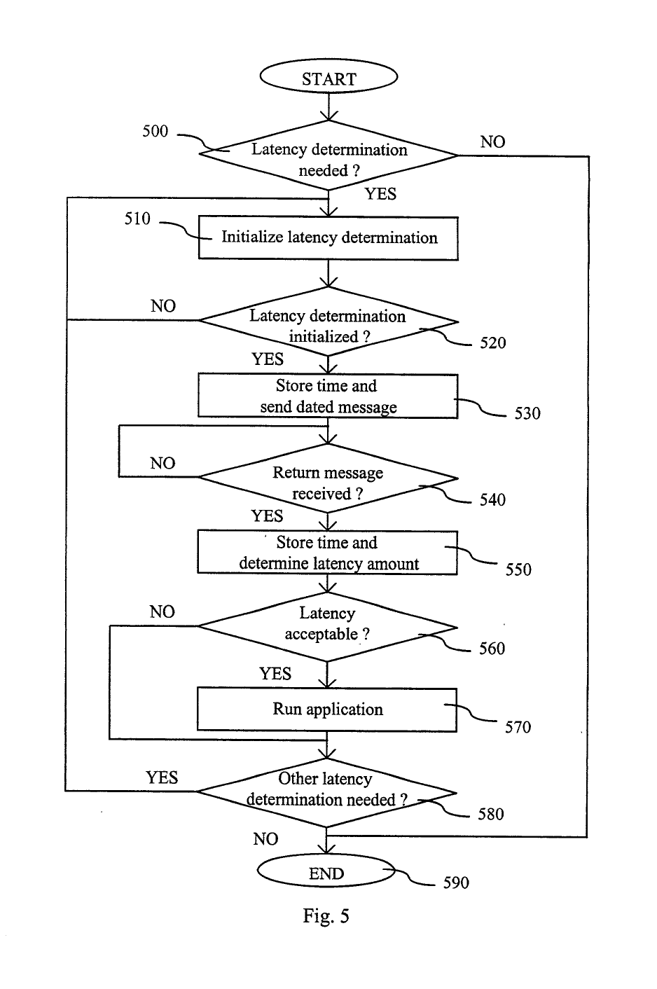

FIG. 5 is a flowchart illustrating a first exemplary embodiment of a latency amount characterization method in accordance with the invention. This latency amount determination method begins in step 500, in which it is determined if a latency amount determination is needed. For example, step 500 may comprise determining which application is to be run. If a latency amount determination is needed, control continues to step 510. Otherwise, control jumps to step 590 in which the process ends. In step 510, the latency amount determination is initialized by, for example, establishing a communication link between each of the communication systems with which the latency amount is be determined. Control then proceeds to 520.

In step 520, it is determined whether the latency amount determination is initialized. If so, control continues to step 530. Otherwise, control returns to step 510. In step 530, a first message is sent to a communication system corresponding to the latency amount that is to be determined and the time at which the first message is sent is stored. Next, in step 540, a determination is made whether a second message, i.e., a return message has been received from the other communication system. If so, control continues to step 550. Otherwise, control returns to step 540.

At step 550, the time at which the return message has been received is stored and the latency amount is determined as being equal to the difference between the time at which the return message has been received, in step 540, and the time at which the first message was sent, in step 530. Control then continues to step 560 in which it is determined whether the latency amount is acceptable for an application to be performed and that involves communication with the other communication system across the network. For example, step 560 may comprise determining whether the latency amount is less than a predetermined amount corresponding to the application. If the latency amount is acceptable, control continues to step 570. Otherwise, control jumps to step 580. In step 570, the application is run and control continues to step 580.

In step 580, it is determined whether another latency amount determination is needed. This can be the case when more than one other communication system is involved in an application or when the latency amount may be variable and an average latency amount or an evolution of the amount of latency are to be determined rather than only one latency amount. If another latency amount determination is needed, control returns to step 510. Otherwise, control continues to step 590 in which the process ends.

The second exemplary embodiment of the latency determination device 130 comprises an user interface 620, a clock 630, a latency amount determination manager 640, a network interface 650 and an application manager 660 and a latency amount equalization manager 670, coupled together by a data and control bus 610. The user interface 620 provides the capability for a first user to communicate with the components of the latency amount determination device 130. The user interface 620 may include one or more of a display, a sound generator, a printer, a keyboard, a mouse, a joystick, a musical instrument, a microphone, a voice recognition system, a pen, a touch screen, or any other input or output devices. The clock 630 provides an information relating to time and may provide a local time, including day, hour, minute, second and thousands of second. The latency amount determination manager 640 manages the determination, display, characterization and/or equalization of the latency amount affecting communication across the network 100.

The network interface 650 allows the latency amount determination device 130 to communicate with the second communication system 120 across the network 100. The application manager 660 manages the application that is used by one or more of the users. The latency amount equalization manager 670 compensates for the latency amount affecting a second user's signals originating from the second communication system 120 and sent over the network 100 in response to a first user's signals over the network. In operation, the latency amount equalization manager 670 equalizes the latency amount by adding a delay before taking into account a signal coming from the first application system 140. The added delay is equal to the latency amount determined by the latency amount determination manager 640.

A first exemplary method for compensating for the latency amount involves adding the same delay to all the signals coming from the first application system. A second exemplary method for compensating for the latency amount involves determining the latency amount for a plurality of signal exchanges between the first and second communication systems 110 and 120, for example, by incorporating a time of sending and a time of reception for each one of the plurality of signals that are conveyed across the network 100.

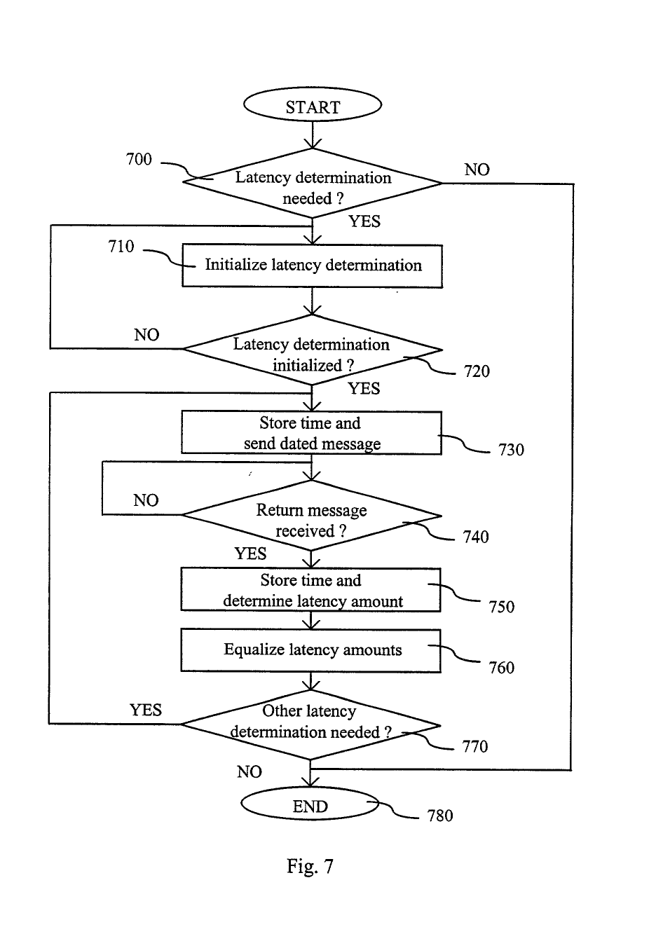

FIG. 7 is a flowchart illustrates a second exemplary embodiment of the latency amount display method in accordance with the invention. This latency amount determination method begins in step 700, in which it is determined if a latency amount determination is needed. For example, step 700 may comprise determining which application is to be run. If a latency amount determination is needed, control continues to step 710. Otherwise, control jumps to step 780, in which the process ends. In step 710, the latency amount determination is initialized, for example, by a communication link between the communication systems being initialized between each of the communication systems between which the latency amount has to be determined preparing for the latency amount determination. Control then proceeds to step 720.

In step 720, it is determined whether the latency amount determination is initialized. If so, control continues to step 730. Otherwise, control returns to step 710. In step 730, a first message is sent from a first communication system to a second communication system over a network and the time at which the first message is sent is stored. Next, in step 740, a determination is made whether a second message, i.e., a return message, has been received from the other communication system. If so, control continues to step 750. Otherwise, control returns to step 740.

At step 750, the time at which the second message, i.e., the return message, has been received is stored and the latency amount experienced by that message is determined as being equal to the difference between the time at which the second message was received, in step 740, and the time at which the first message was sent, in step 730. Control then continues to step 760, in which the latency amount is compensated for by adding a delay to the transmission of signals from the local user to the application. The delay is equal to the latency amount that has been determined in step 750. Thanks to this added delay, the response time that each user enjoys is the same. Control then proceeds to step 770.

In step 770, it is determined whether another latency amount determination is needed and further latency amount compensation should be performed. This can be the case when more than one other communication system is involved in an application or when the latency amount may be variable and an average latency amount or an evolution of the amount of latency are to be determined instead of only one latency amount. If another latency amount determination is needed, control returns to step 710. Otherwise, control continues to step 780 in which the process ends.

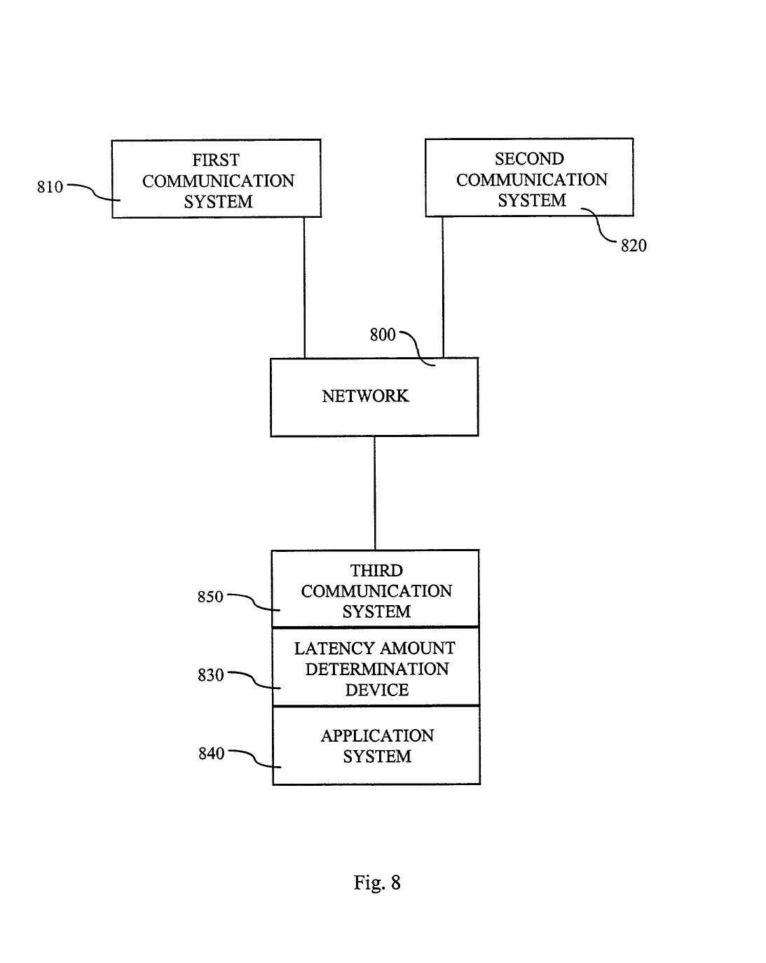

FIG. 8 illustrates the architectural relationship of a latency amount determination device 830 in accordance with the exemplary embodiments of this invention and coupled to a third communication system 850. The third communication system 850 is coupled to a first communication system 810 and to a second communication system 820 across a network 800. The latency amount determination device 830 is also coupled to an application system 840. The first communication system 810 and the second communication system 820 both communicate with the third communication system 850.

In the exemplary embodiment of the latency determination device according to the invention shown in FIG. 8, the application system 840 performs an application that requires communication between the third communication system 860 and both the first communication system 810 and the second communication system 820. For example, the application system 840 comprises the main portion of a game software that allows a first user using the first communication system 810 to play with or against a second user using the second communication system 820.

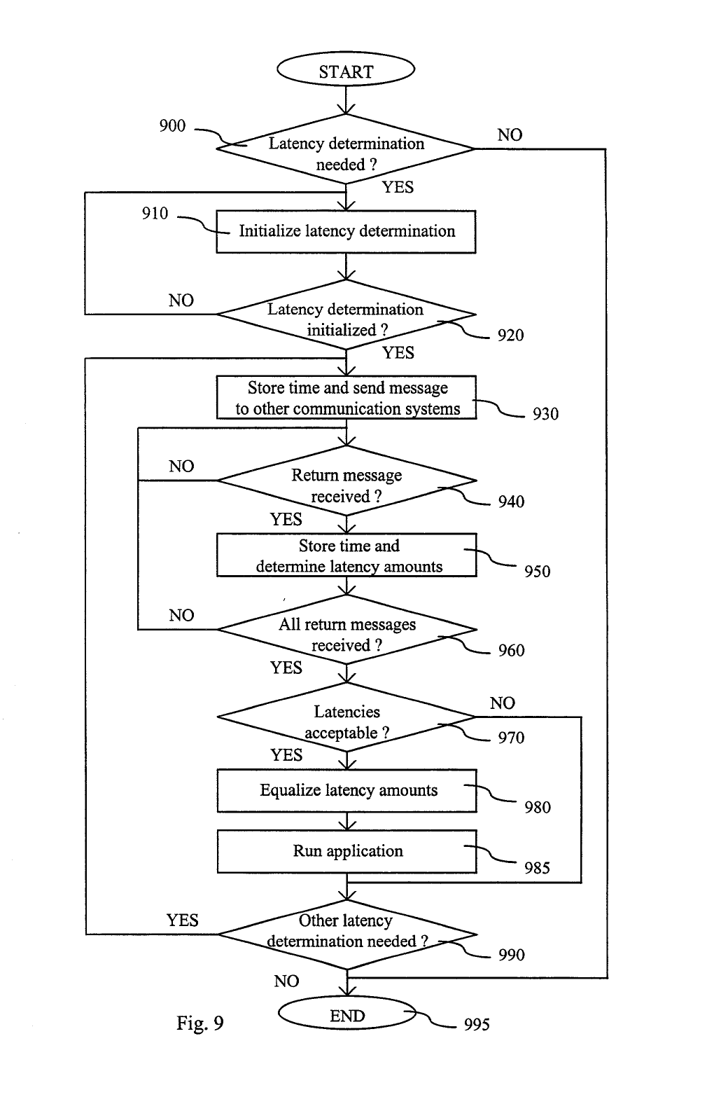

FIG. 9 is a flowchart illustrating a second exemplary embodiment of an amount of latency characterization and equalization method in accordance with the invention. This latency determination method begins in step 900, in which it is determined if a latency determination is needed. For example, step 900 may comprise determining which application is to be run. If a latency amount determination is needed, control continues to step 910. Otherwise, control jumps to step 995 in which the process ends. In step 910, the amount of latency determination is initialized, by, for example, establishing a communications link between each of the communication systems between which the amount of latency will be determined.

In step 920, it is determined whether the necessary links have been established to initialize the latency amount determination. If so, control continues to step 930. Otherwise, control returns to step 910. In step 930, a first message is sent to each of the communication systems for which the amount of latency will be determined and the time at which that first messages were sent is stored. Next, in step 940, a determination is made whether a return message has been received from one of the communication systems to which the message has been sent. If so, control continues to step 950. Otherwise, control returns to step 940.

At step 950, the time at which the return message is received is stored and the amount of latency is determined as being equal to the difference between the time at which the return message has been received, in step 940, and the time at which the first message has been sent, in step 930. Control then continues to step 960 in which it is determined whether all the expected return messages have been received. If so, control continues to step 970. Otherwise, control returns to step 940.

In step 970, a determination is made whether the latency amounts are acceptable for an application to be performed and involving communication with the other communication systems across the network. For example, step 970 may comprise determining whether the latency amounts are less than a predetermined amount. If the latency amounts are acceptable, control continues to step 980. Otherwise, control jumps to step 990.

In step 980, the latencies are equalized or compensated by adding a delay to the transmission of signals from communication systems that do not suffer from the higher amount of latency. For each one of the communication systems involved, the delay is equal to the difference between the higher amount of latency and the amount of latency for that communication system. In step 985, the application runs and control continues to step 990.

In step 990, it is determined whether another amount of latency determination is needed. This can be the case when more than one other communication system is involved in an application or when the amount of latency may be variable and an average amount of latency or an evolution of the amount of latency are to be determined over a period of time instead of only one amount of latency. If another amount of latency determination is needed, control returns to step 910. Otherwise, control continues to step 995 in which the process ends.

It should be appreciated that the amount of latency determination device may also determine the difference between the amount of latency for the communication between a specific communication system and the other communication systems involved in an application. For example, the difference may be determined by initializing to zero and starting a clock when the first response message is received and reading the value of this clock each time that another response message is received. The value of the clock for a message coming from a particular communication system is equal to the difference between the amount of latency for that communication system and the amount of latency for the communication system from which the response message is first received. In such a case, compensating the amount of latency for a particular communication system is performed by adding a delay equal to the difference between the higher value of the clock at a moment of reception of a response message and the value of that clock when the response message is received from that particular communication system.

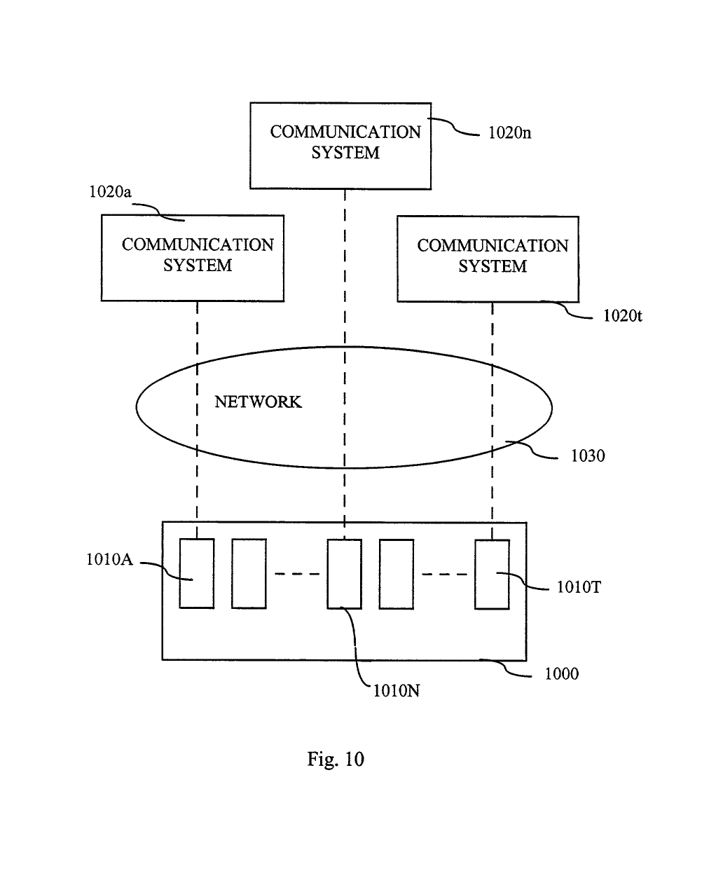

In the exemplary embodiment outlined in FIG. 10, a latency equalization manager 1000 is coupled to a number t of communication systems 1020a to 1020t, through a communication network 1030. The latency equalization manager comprises a set of T programmable delay lines 1010A to 1010T, each communication system 1020i being coupled to one programmable delay line 1010i of the set of programmable delay lines 1010A to 1010T.

Define T_{a,M} the ping time from the communication system 1020a to the latency equalization manager 1000, T_{b,M} the ping time from the communication system 1020b to the latency equalization manager 1000, . . . T_{n,M} the ping time from the communication system 1020n to the latency equalization manager 1000, T_{i,j}, the ping time from the communication system 1020i to the communication system 1020j. If the network is stable and well routed, then T_{i,j}≦T_{i,M}+T_{j,M}.

This gives a first order grouping based on latencies. Additionally, the latency equalization manager 1000 may manage other criteria, such as, the user skill levels or the type of game played.

When a user i connects to the equalization manager 1000, the ping time T_{i,M} is determined and the equalization manager proposes to user i a set of potential partners based on the criteria managed by the equalization manager. User i, or his application, may select one or more partners in the proposed list.

Once the set of partners for an application is determined based on the wishes of all the potential partners, the maximal amount of latency (and other managed criterias, if any) is determined. Next, each partner is assigned a handicap equal to the difference between the maximal amount of latency and the actual amount of latency for that partner. This handicap is sent to the programmable delay line for that partner and the delay is applied to any signal sent by that partner before the application takes into account that signal.

It should be appreciated that further to the amount of latency for each partner, the latency equalization manager may take into consideration additional handicaps relating to physical response times for handicapped people, skill handicaps, age, processing systems, speed of processor of the user computer, for example.

The latency amount determination managers and equalizers may be, in the exemplary embodiments of the invention shown in FIGS. 3 and 6, a microprocessor that uses software to implement exemplary embodiments of the methods and devices according to this invention. However, each of the latency amount determination managers and equalizers can also be implemented on a special purpose computer, a programmed microcontroller and peripheral integrated circuit elements, an ASIC or other integrated circuit, a digital signal processor, a hardwire electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 4, 5, 7 and 9 can be used to implement the latency amount determination managers and equalizers.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

Additionally, the communication networks and network services managed by the exemplary embodiments of the invention are not limited to those expressly identified above. The exemplary embodiments of the invention may be used to manage any type of now known or future developed communication network and network service.

Also, it should be appreciated that an amount of latency experienced during communication between a first and third communication system may be compensated for based on an amount of latency experienced during communication between a second and third communication system. That is, based on the determined amounts of latency, one of the determined amounts may be compensated for so as to provide equal or approximately equal amounts of latencies being experienced by the communications between the first and third and the second and third communication systems. Additionally, such compensation may be performed following a determination that both amounts of latency are below a required maximum amount of latency.

What is claimed is:

1. A method for communicating between a first communication system and a second communication system, the method comprising:
establishing a communication link between the first communication system and the second communication system;
determining at least one amount of latency affecting communication between the first communication system and the second communication system; and
displaying the determined amount of latency.

2. The method of claim 1, wherein determining at least one amount of latency affecting communication between the first communication system and the second communication system comprises:
sending a first signal from the first communication system to the second communication system, the first signal requiring an immediate response from the second communication system, and
comparing a time at which the first signal is sent and a time at which the response is received by the first communication system.

3. The method of claim 1, wherein determining at least one amount of latency affecting communication between the first communication system and the second communication system comprises:
sending a first signal from the first communication system to the second communication system, the first signal requiring a response from the second communication system, the response comprising information about a time at which the first signal is received by the second communication system and a time at which the response is sent by the second communication system,
comparing the time at which the signal is sent by the first communication system and the time at which the response is received by the first communication system to determine a first difference,
comparing the time at which the first signal is received by the second communication system and the time at which the response is sent by the second communication system to determine a second difference, and
comparing the first and second differences to determine the at least one amount of latency.

4. A method for communicating between a first communication system and a second communication system, the method comprising:
establishing a communication link between the first communication system and the second communication system;
determining at least one amount of latency affecting communication between the first communication system and the second communication system; and
comparing the determined amount of latency with a required maximum amount of latency.

5. The method of claim 4, further comprising comparing the determined amount of latency with a required maximum latency and if the determined amount of latency is lower than the required maximum latency, compensating for the determined amount of latency.

6. The method of claim 4, wherein determining at least one amount of latency affecting communication between the first communication system and the second communication system comprises:
sending a first signal from the first communication system to the second communication system, the first signal requiring an immediate response from the second communication system, and
comparing a time at which the first signal is sent and a time at which the response is received by the first communication system.

7. The method of claim 4, wherein determining at least one amount of latency affecting communication between the first communication system and the second communication system comprises:
sending a first signal from the first communication system to the second communication system, the first signal requiring a response from the second communication system, the response comprising information about a time at which the first signal is received by the second communication system and a time at which the response is sent by the second communication system,
comparing the time at which the signal is sent by the first communication system and the time at which the response is received by the first communication system to determine a first difference,
comparing the time at which the first signal is received by the second communication system and the time at which the response is sent by the second communication system to determine a second difference, and
comparing the first and second differences to determine the at least one amount of latency.

8. A method for communicating between a first communication system and a second communication system, the method comprising:
establishing a communication link between the first communication system and the second communication system;
determining at least one amount of latency affecting communication between the first communication system and the second communication system; and
compensating for the determined amount of latency.

9. The method of claim 8, further comprising comparing the determined amount of latency with a required maximum latency and if the determined amount of latency is lower than the required maximum latency, compensating for the determined amount of latency.

10. The method of claim 8, wherein determining at least one amount of latency affecting communication between the first communication system and the second communication system comprises:
sending a first signal from the first communication system to the second communication system, the first signal requiring an immediate response from the second communication system, and
comparing a time at which the first signal is sent and a time at which the response is received by the first communication system.

11. The method of claim 8, wherein determining at least one amount of latency affecting communication between the first communication system and the second communication system comprises:
sending a first signal from the first communication system to the second communication system, the first signal requiring a response from the second communication system, the response comprising information about a time at which the first signal is received by the second communication system and a time at which the response is sent by the second communication system,
comparing the time at which the signal is sent by the first communication system and the time at which the response is received by the first communication system to determine a first difference,
comparing the time at which the first signal is received by the second communication system and the time at which the response is sent by the second communication system to determine a second difference, and
comparing the first and second differences to determine the at least one amount of latency.

12. A method for communicating between a first communication system, a second communication system and a third communication system, the method comprising:
establishing a communication link between the first communication system and the third communication system,
determining at least one amount of latency affecting communication between the first communication system and the third communication system,
establishing a communication link between the second communication system and the third communication system, and
determining at least one amount of latency affecting communication between the second communication system and the third communication system.

13. The method of claim 12, further comprising comparing both the amount of latency affecting communication between the first and third communication systems and the amount of latency affecting communication between the second and third communication system with a required maximum latency.

14. The method of claim 12, further comprising compensating for a difference between the amount of latency affecting communication between the first and third communication systems and the amount of latency affecting communication between the second and third communication system.

15. The method of claim 12, further comprising comparing the amount of latency affecting communication between the first and third communication systems and the amount of latency affecting communication between the second and third communication systems with a required maximum latency and if each of the amount of latency affecting communication between the first and third communication systems and the amount of latency affecting communication between the second and third communication system is lower than the required amount of latency, compensating for the difference between the amount of latency affecting communication between the first and third communication systems and the amount of latency affecting communication between the second and third communication system.

16. The method of claim 12, wherein determining at least one amount of latency affecting communication between either the first and the third communication systems or the second and third communication systems comprises:
sending a first signal from one of the two communication systems to the other one of the two communication systems, the first signal requiring an immediate response from the other one of the two communication systems, and
comparing the time at which the first signal is sent by the one of the two communication systems and the time at which the response is received by the one of the two communication systems.

17. The method of claim 12, wherein determining at least one amount of latency affecting communication between either the first and the third communication systems or the second and third communication systems comprises:
sending a first signal from one of the two communication systems to the other one of the two communication systems, the first signal requiring a response from the other one of the two communication systems, the response comprising the time at which the first signal is received by the other one of the two communication system and the time at which the response is sent by the other one of the two communication system,
comparing the time at which the first signal is sent and the time at which the response is received to determine a first difference,
comparing the time at which the first signal is received and the time at which the response is sent to determine a second difference, and
comparing the first and second differences.

18. A device for communicating between a first communication system and a second communication system, the device comprising:
the first communication system that establishes a communication link with the second communication system;
a latency determination device coupled to the first communication system, that determines at least one amount of latency affecting communication between the first communication system and the second communication system; and
an user interface coupled to the latency determination device, that displays the determined amount of latency.

19. A device for communicating between a first communication system and a second communication system, the device comprising:
the first communication system that establishes a communication link with the second communication system; and
a latency determination device coupled to the first communication system, that determines at least one amount of latency affecting communication between the first communication system and the second communication system, wherein the latency determination device compares the determined amount of latency with a required maximum amount of latency.

20. The device of claim 19, wherein the latency determination device compares the determined amount of latency with a required maximum latency and if the determined amount of latency is lower than the required maximum latency, the latency determination device compensates for the determined amount of latency.

21. A device for communicating between a first communication system and a second communication system, the device comprising:
the first communication system that establishes a communication link with the second communication system;
a latency determination device coupled to the first communication system, that determines at least one amount of latency affecting communication between the first communication system and the second communication system, wherein the latency determination device compensates for the determined amount of latency.

22. A device for communicating between a first communication system, a second communication system and a third communication system, the device comprising:
the third communication system that establishes a communication link with the first communication system and a communication link with the second communication system,
a latency determination device that determines at least one amount of latency affecting communication between the first communication system and the third communication system and at least one amount of latency affecting communication between the second communication system and the third communication system.

23. The device of claim 22, wherein the latency determination device compares both the amount of latency affecting communication between the first and third communication systems and the amount of latency affecting communication between the second and third communication system with a required maximum latency.

24. The device of claim 22, wherein the latency determination device compensates for a difference between the amount of latency affecting communication between the first and third communication systems and the amount of latency affecting communication between the second and third communication system.

25. The device of claim 22, wherein the latency determination device compares both the amount of latency affecting communication between the first and third communication systems and the amount of latency affecting communication between the second and third communication systems with a required maximum latency and if each of the amount of latency affecting communication between the first and third communication systems and the amount of latency affecting communication between the second and third communication system is lower than the required amount of latency, the latency determination device compensates for the difference between the amount of latency affecting communication between the first and third communication systems and the amount of latency affecting communication between the second and third communication system.

26. The device of claim 22, wherein for determining at least one amount of latency affecting communication between either the first and the third communication systems or the second and third communication systems:
the third communication system sends a first signal to the other communication system, the first signal requiring an immediate response from the other communication system;
the third communication system receives the response; and
the latency determination device compares the time at which the first signal is sent and the time at which the response is received.

27. The device of claim 22, wherein for determining at least one amount of latency affecting communication between either the first and the third communication systems or the second and third communication systems:
the third communication system sends a first signal to the other communication system, the first signal requiring a response from the other communication system, the response comprising the time at which the first signal is received by the other communication system and the time at which the response is sent by the other communication system;
the third communication system receives the response;
the latency determination device compares the time at which the first signal is sent and the time at which the response is received to determine a first difference;
the latency determination device compares the time at which the first signal is received and the time at which the response is sent to determine a second difference; and
the latency determination device compares the first and second differences.
